(19) United States
(12) Patent Application Publication
(10) Pub. No.: US 2005/0132899 A1
(43) Pub. Date: Jun. 23, 2005

(54) Conveyor oven with energy saving baffle mechanism and method

(75) Inventors: Ming Lung Huang, Fort Wayne, IN (US); Steve Milz, Fort Wayne, IN (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Lincoln Foodservice Products, Inc.

(21) Appl. No.: 10/991,972

(22) Filed: Nov. 18, 2004

Related U.S. Application Data
(60) Provisional application No. 60/523,199, filed on Nov. 18, 2003.
(60) Provisional application No. 60/612,718, filed on Sep. 24, 2004.

(51) Int. Cl. A23L 1/00

(52) U.S. Cl. 99/386

(57) ABSTRACT

A conveyor oven with improved energy efficiency. The energy efficiency is achieved by providing baffles at an inlet and an outlet of the conveyor oven. The baffles are individually controlled to be closed during cooking operations except for the time required for the passage of a food product through the respective inlet and outlet. The baffles can be operated manually or by electrically driven devices such as solenoids or electric motors. A controller can be used to control the open and closed times of the baffles based on sensor inputs as well as the speed of the conveyor, a predetermined length of the oven cavity between the inlet and outlet and a size of the food product.

### RELATED APPLICATIONS

This application claims the benefit of U.S. Provisional Patent Application No. 60/523,199, filed on Nov. 18, 2003, and of U.S. Provisional Patent Application No. 60/612,718, filed on Sep. 24, 2004, the entire contents of both of which are hereby incorporated by reference.

### FIELD OF THE INVENTION

The present invention relates to a conveyor oven with an energy saving baffle mechanism and method.

### DISCUSSION OF THE BACKGROUND ART

Conveyor ovens typically transport food on a conveyor along a cooking path between an inlet and an outlet. Heat provided along the cooking path can escape the oven through the inlet and the outlet. The lost heat can seriously affect the thermal efficiency of the oven.

Thus, there is a need to reduce the heat loss in a conveyor oven.

### SUMMARY OF THE INVENTION

A conveyor oven of the present invention comprises an oven cavity that has at least one opening. A conveyor is positioned to extend into the oven cavity via the opening. A source of thermal energy provides heat in the oven cavity. A baffle is located within the opening and is operable between a closed position and an open position. The heat loss from the oven cavity via the opening is reduced when the baffle is in the closed position versus when the baffle is in the open position.

In the conveyor oven of the present invention, the opening is at least one selected from the group consisting of: inlet and outlet.

The conveyor oven of the present invention preferably includes a frame member, wherein the baffle is operatively coupled to the frame member. In one embodiment, the frame member preferably comprises a pair of spaced apart pegs located above the opening. The baffle comprises a pair of vertical slots that mate with the pegs. The motion is a sliding motion of the baffle and pegs throughout a length of the slots.

Preferably, a controller controls the baffle to be in the closed position except for a time required for a passage of a food product carried by the conveyor through the opening, thereby minimizing the heat loss. The baffle further comprises a module that comprises a drive unit that controls the movement of the baffle between an open position and a closed position. The controller controls the baffle to be in the open and closed positions based on a position of the food product relative to the opening, a speed of the conveyor and a predetermined length of the oven cavity.

Preferably, the drive unit is selected from the group consisting of: a motor, linear actuator, a mechanical gear and chain drive, and a solenoid valve. Moreover, the drive unit causes the baffle to be in the open position only for the time required for a passage of a food product carried by the conveyor through the opening.

Preferably, the module further comprises a sensor that senses at least one condition selected from the group consisting of: a food product, open baffle, closed baffle and any combination of open baffle and closed baffle. The module further comprises a mechanical linkage that moves the baffle between the open and closed positions.

In another embodiment of the conveyor oven of the present invention, the conveyor oven further comprises a mechanical linkage, which comprises a rail, a slider and one or more links. The electrically driven device via at least one of the links moves the slider along the rail. The baffle is coupled to the slider via another one of the links so as to follow the motion of the slider.

A method of the present invention controls a conveyor oven that comprises an oven cavity that includes at least one opening and a conveyor that extends through the opening. The method comprises providing thermal energy in the oven cavity and, during a cooking operation, covering the opening with a baffle when a food product is disposed within the cavity. The heat loss from the oven cavity via the opening is reduced when the baffle is in a closed position versus when the baffle is in an open position.

The baffle is driven with a drive unit between an open position and a closed position in which the opening is uncovered and covered, respectively.

In an alternate embodiment of the method of the present invention, the baffle is controlled to be in the open and closed positions based on a position of the food product relative to the opening, a speed of the conveyor and a predetermined length of the oven cavity.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1 is a block diagram in part and an elevation view in part of one embodiment of the conveyor oven of the present invention;

FIG. 2 is a perspective view of another embodiment of the conveyor oven of the present invention;

FIG. 3 is a perspective view of a detail 3 of the conveyor oven of FIG. 2;

FIG. 4 is a perspective view of the baffle mechanism of FIG. 3;

FIG. 5 is a perspective view another embodiment of the conveyor oven of the present invention;

FIG. 6 is a perspective view of a detail 6 of FIG. 5;

FIG. 7 is an end view of the baffle mechanism of the conveyor oven of FIG. 5; and

FIG. 8 is a front elevation view of the baffle mechanism of the conveyor oven of FIG. 5.

### DESCRIPTION OF THE PREFERRED EMBODIMENT

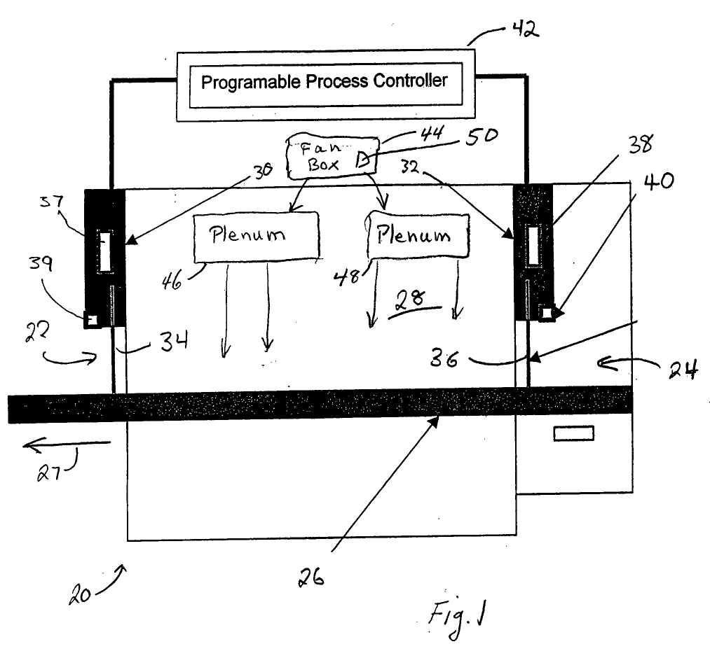

Referring to FIG. 1, a conveyor oven 20 of the present invention comprises an oven cavity 28 with an outlet 22 and an inlet 24. A conveyor 26 is positioned to convey food products in the direction shown by an arrow 27, the food products entering oven cavity 28 via inlet 24 and leaving via outlet 22. A module 32 and a module 30 are located adjacent inlet 24 and outlet 22, respectively. In the embodiment shown in FIG. 1, modules 30 and 32 are mounted above conveyor 26. A baffle 34 and a baffle 36 are mechanically coupled to modules 30 and 32, respectively. A controller 42 is electrically coupled to modules 30 and 32. Baffle 34 and module 30 comprise a baffle mechanism and baffle 36 and module 32 comprise a baffle mechanism.

Module 30 includes a drive unit shown as a solenoid valve 37 and a proximity sensor 39. Module 32 includes a drive unit shown as a solenoid valve 38 and a proximity sensor 40. Controller 42 responds to signals from proximity sensors 39 and 40 to control solenoid valves 37 and 38 to raise and lower baffles 34 and 36 so as to limit the loss of thermal energy via inlet 24 and outlet 36. Proximity sensors 39 and 40 are located to detect a food product presence on conveyor 26 outside of oven cavity 28.

A suitable source of thermal energy is provided to provide heat in oven cavity 28 for cooking the food products as they traverse oven cavity 28 on conveyor 26. For example, a fan box 44 and one or more plenums 46 and 48 are provided in fluid communication with oven cavity 28 to circulate heated air in a path that includes fan box 44, plenums 46 and 48 and one or more air returns (not shown). The circulating air is heated by a heater 50 that may be located in fan box 44. Plenums 46 and 48 can be designed to provide columns of impingement air toward conveyor 26. Alternatively, or additionally, similar plenums in fluid communication with fan box 44 and oven cavity 28 could be located below conveyor 26. Alternatively, or additionally, a radiant heater (e.g., an infrared heater) could be disposed above and/or below conveyor 26.

Controller 42 controls the opening and closing of baffles 36 and 34 to limit thermal loss via inlet 24 and outlet 22. That is, controller 42 opens baffle 36 only for the time required for a passage of a food product through inlet 24 to enter oven cavity 28 and opens baffle 34 for the time required for a passage of the food product through outlet 22 to leave oven cavity 28. The arrival of a food product on conveyor 26 outside of inlet 24 is detected by proximity sensor 40, which provides an entry signal to controller 42. Controller 42 responds by controlling solenoid valve 38 to open or raise baffle 36. Baffle 36 remains open until the food product is entirely within oven cavity 28. Controller 42 then controls solenoid valve 38 to lower or close baffle 36.

Oven cavity 28 can be of any predetermined length. Modules 30 and 32 are in communication with controller 42 to provide information regarding the location of the food product on conveyor 26. Controller 42, based on the conveyor speed and food product size determines an entry time period that baffle 36 must remain open to allow entry of the food product via inlet 24. Upon expiration of the entry time, controller 42 causes solenoid valve 38 to lower or close baffle 36. Controller 42, based on the predetermined length of oven cavity 28, calculates the travel time of the food product inside oven cavity 28. Upon the expiration of the travel time, controller 42 then provides a signal to solenoid valve 37 to open baffle 34 to allow the food product to leave oven cavity 28 via outlet 22. Proximity sensor 39 detects when the food product has exited oven cavity 28 and provides a signal to controller 42. Controller 42 responds to this signal to cause solenoid valve 37 to lower or close baffle 34. By controlling the opening and closing of baffles 34 and 36, the energy reduction of conveyor oven 20 is about 30% for an air impingement pizza oven as compared to a continuous full open condition of inlet 24 and outlet 22.

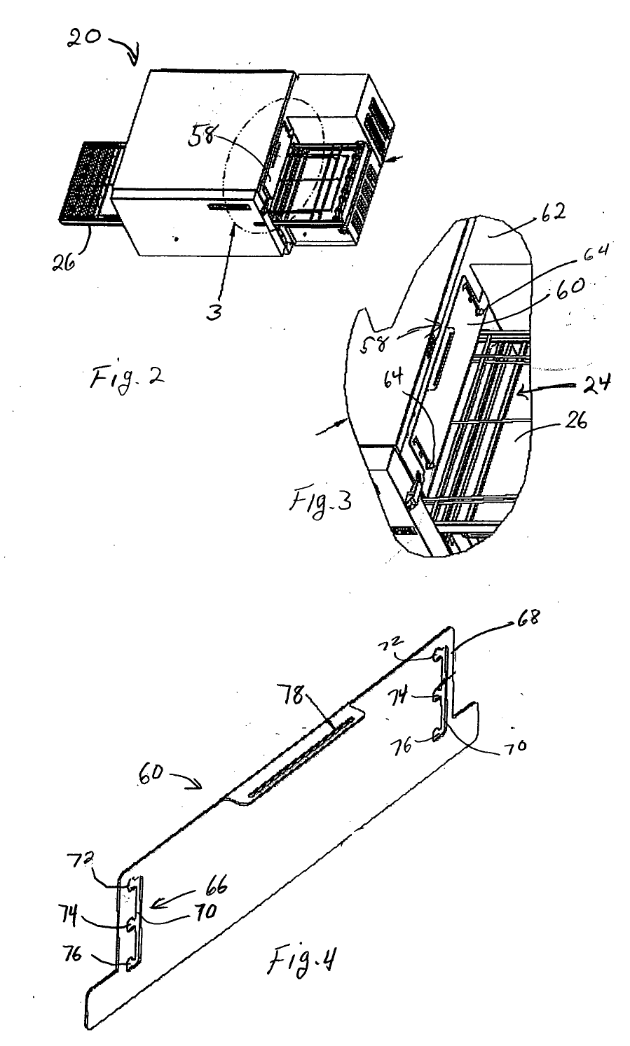

Referring to FIGS. 2-4, an alternate embodiment of the conveyor oven of the present invention comprises a baffle mechanism that includes a baffle 60 disposed at inlet 24 of conveyor oven 20. A duplicate baffle mechanism (not shown) is located on the opposite end or outlet of conveyor oven 20. Referring to FIGS. 3 and 4, baffle 60 comprises an elongated plate that has a cutout 66 located near one vertical edge and another cutout 68 located near an opposite vertical edge. The shape of baffle 60 and cutouts 66 and 68 are arranged to provide for raising and lowering baffle 60 manually across inlet 24 of conveyor oven 20, immediately above conveyor 26. To this end, a frame member 62 of conveyor oven 20 comprises a pair of pegs 66 that are spaced apart horizontally so as to mate with cutouts 66 and 68 of baffle 60.

Cutouts 66 and 68 each include a vertical slot 70 that is connected to a plurality of notches 72, 74 and 77 that are spaced vertically along slot 70. The arrangement of slot 70 and notches 72, 74 and 76 provides for movement of baffle 60 without a need to remove it completely from frame member 62. This eliminates any need for tightly fastening baffle 60 to frame member 62. Baffle 60 can be moved easily vertically along slot 70 and horizontally into and out of notches 72, 74 or 76 with common tools or by hand, with hand protection for the high heat. When pegs 64 are in the top most notches 72, baffle 60 is in a lowered or closed position, which is the energy saving position. To shift baffle 60 to a fully raised or opened position, a lip 78 of baffle 60 can be grasped to manually move baffle 60. Baffle 60 is first raised and then slid horizontally so that pegs 64 are in slots 70. Baffle 60 is then raised by sliding vertically in slots 70 until notches 76 reach the level of pegs 64. Baffle 60 is then moved horizontally until pegs 64 are in notches 76. When in this position, food products can freely enter oven cavity 28. To return to the energy efficient position, baffle 60 is moved horizontally until pegs 64 are in slots 70 and then slid vertically downwardly until notches 72 reach the level of pegs 64. Baffle 60 is then moved horizontally until pegs 64 are in notches 72. Intermediate notches 74 allow baffle 60 to be partially open for a food product having a lower height. It will be apparent to those skilled in the art that additional intermediate notches could be provided to accommodate a plurality of different food product heights.

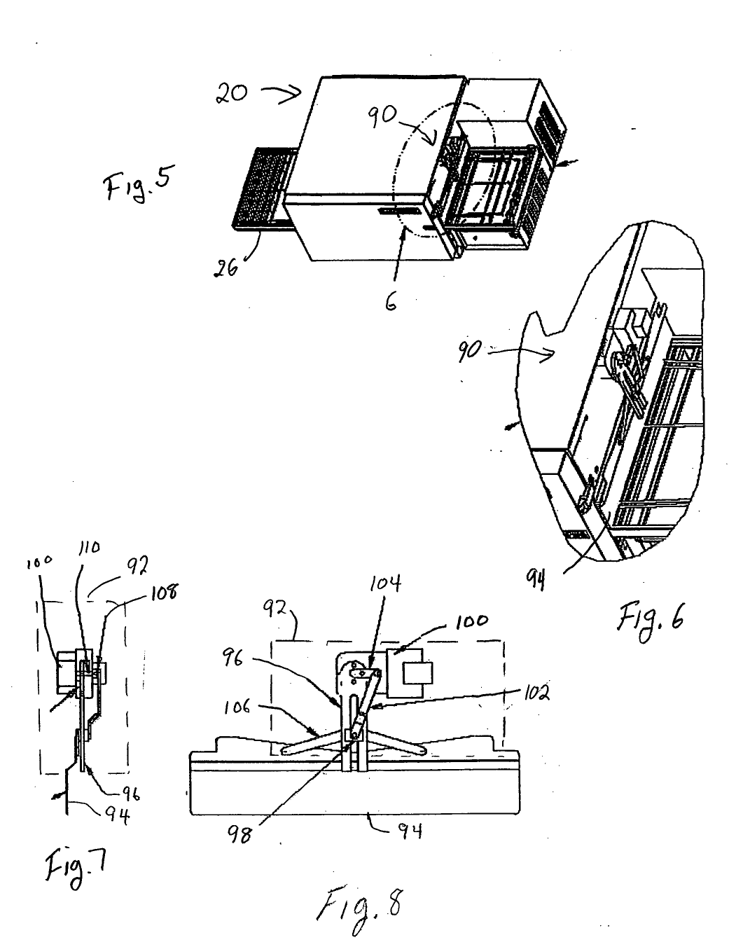

Referring to FIGS. 5-8, another alternate embodiment of the baffle mechanism of the present invention comprises a baffle mechanism 90 disposed at inlet 24 of conveyor oven 20. A duplicate baffle mechanism (not shown) is located at the opposite end or outlet of conveyor oven 20. Baffle mechanism 90 includes a module 92 and a baffle 94. Module 92 is mechanically couple to baffle 94 and is operative to move baffle 94 between a lowered or closed position and an upper or opened position. Module 92 comprises a drive unit shown as an electric motor 100 that is operative to drive a mechanical linkage that raises and lowers baffle 94. The mechanical linkage includes a link 102, a link 104 and a drive arm 106 that are configured for motion up and down a rail 96. A slider is positioned to slide up and down in rail 96 and is coupled to drive arm 106 and to link 104 via link 102. Drive arm 106 is also fastened to baffle 94. Motor 100 is coupled to link 104 via a bushing 108. As motor 100 drives the linkage of links 104 and 102, drive arm 106 and slider 98 to move up and down rail 96 carrying baffle 94 between a closed position and an open position. A magnet 110 is used in combination with a hall-effect sensor (not shown) to signal a fully up or a fully down position of baffle 94, the signal being used to control motor 100.

Motor 100 may be activated in a variety of ways. A simple switch (not shown) can be used to turn motor 100 on and off to raise or lower baffle 94. A more complex method using one or more microprocessors can have sensors or logic based algorithms to derive the energy savings without human intervention. This methodology would provide the optimum energy savings, as the system would not require an individual interpretation of events to determine the most efficient times to energize the system.

The conveyor oven of the present invention improves the thermal efficiency by providing an inlet baffle and an outlet baffle that are each controlled to open and close based on the location of food on the conveyor. A process controller responds to proximity sensors 39 and 40 to calculate the opening and closing times of the baffles based on the speed of the conveyor.

The present invention having been thus described with particular reference to the preferred forms thereof, it will be obvious that various changes and modifications may be made therein without departing from the spirit and scope of the present invention as defined in the appended claims.

1. A conveyor oven comprising:
an oven cavity having at least one opening;
a conveyor positioned to extend into said oven cavity via said opening;
a source of thermal energy that provides heat in said oven cavity; and
a baffle that is located within said opening and that is operable between a closed position and an open position, whereby heat loss from said oven cavity via said opening is reduced when said baffle is in said closed position versus when said baffle is in said open position.

2. The conveyor oven of claim 1, wherein said opening is at least one selected from the group consisting of: inlet and outlet.

3. The conveyor oven of claim 1, further comprising a frame member, and wherein said baffle is operatively coupled to said frame member.

4. The conveyor oven of claim 3, wherein said frame member comprises a pair of spaced apart pegs located above said opening, wherein said baffle comprises a pair of vertical slots that mate with said pegs, and wherein said motion is a sliding motion of said baffle and pegs throughout a length of said slots.

5. The conveyor of claim 1, further comprising a controller that controls said baffle to be in said closed position except for a time required for a passage of a food product carried by said conveyor through said opening.

6. The conveyor of claim 5, wherein said baffle further comprises a drive unit that drives said baffle, and wherein said controller controls said drive unit.

7. The conveyor of claim 5, wherein said controller controls said baffle to be in said open and closed positions based on a position of said food product relative to said opening, a speed of said conveyor and a predetermined length of said oven cavity.

8. The conveyor oven of claim 1, wherein said baffle further comprises a module that comprises a drive unit, which controls said movement of said baffle between an open position and a closed position.

9. The conveyor of claim 8, wherein said drive unit is selected from the group consisting of: a motor, linear actuator, a mechanical gear and chain drive, and a solenoid valve.

10. The conveyor of claim 8, wherein said drive unit causes said baffle to be in said open position only for the time required for a passage of a food product carried by said conveyor through said opening.

11. The conveyor of claim 8, wherein said module further comprises a sensor that senses at least one condition selected from the group consisting of: a food product, open baffle, closed baffle and any combination of open baffle and closed baffle.

12. The conveyor of claim 8, wherein said module further comprises a mechanical linkage that moves said baffle between said open and closed positions.

13. The conveyor of claim 12, wherein said mechanical linkage comprises a rail, a slider and one or more links, wherein said drive unit, via at least one of said links, moves said slider along said rail, wherein said baffle is coupled to said slider via another one of said links so as to follow the motion of said slider.

14. A method of controlling a conveyor oven that comprises an oven cavity that includes at least one opening and a conveyor that extends through said opening, said method comprising:
providing thermal energy in said oven cavity; and
during a cooking operation, covering said opening with a baffle when a food product is disposed within said oven cavity, whereby heat loss from said oven cavity via said opening is reduced when said baffle is in a closed position versus when said baffle is in an open position.

15. The method of claim 14, further comprising: driving said baffle with a drive unit between said open position and said closed position, whereby said opening is uncovered and covered, respectively.

16. The method of claim 15, wherein said baffle is controlled to be in said open and closed positions based on a position of said food product relative to said opening, a speed of said conveyor and a predetermined length of said oven cavity.
